(19) United States
(12) Patent Application Publication
(10) Pub. No.: US 2004/0125395 A1
(43) Pub. Date: Jul. 1, 2004

(54) Printing control method and apparatus

(75) Inventor: Akiko Onishi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/734,211

(22) Filed: Dec. 15, 2003

(30) Foreign Application Priority Data
Dec. 17, 2002 (JP) 2002-365833

(51) Int. Cl. G06F 15/00; G06F 3/12

(52) U.S. Cl. 358/1.13; 358/1.15

(57) ABSTRACT

This invention allows printing in settings different between the front and back sides of a medium in double-sided printing. When the type of medium or the color/monochrome printing mode changes between front and back sides, a high-quality image is formed by a printing method suitable for each setting. For this purpose, a printing control method of converting original data into print data processible by a printing apparatus includes a setting step of setting a basic setting applied to the whole print data in generating the print data, a double-sided printing setting, and a back-side setting applied to a page corresponding to the back side of a sheet serving as a printing medium in the double-sided printing setting, and a conversion step of converting the data into the print data in accordance with the basic setting and the back-side setting set in the setting step.

### FIELD OF THE INVENTION

The present invention relates to a printing control method and apparatus which convert drawing data created by a host computer or the like into a predetermined format and output the resultant data to a printing apparatus and, more particularly, to a printing control method and apparatus which output data to a printing apparatus having an automatic double-sided printing unit.

### BACKGROUND OF THE INVENTION

To print data created by various applications, the operator opens the printing dialog of an application, designates a printer for use, and executes printing. At this time, a printer driver serving as software for generating a data format (to be referred to as print data hereinafter) for processing by the designated printer can designate various printing settings (to be also referred to as printing options). For example, processing executed during generation of print data changes between printing of a photographic image and printing of text data. The printer driver must perform image processing suited to each data. It is therefore preferable to select an image processing method corresponding to the type of data to be printed. An optimal image processing method and printing speed change between printing on plain paper and printing on photopaper for printing a photograph by an ink-jet printer. To perform printing suited to paper for use, paper for use must be selected.

As items on the paper size, layout, and the like, there can be designated the paper size and direction, the printing layout such as N-up printing of laying out a plurality of pages (to be referred to as logical pages hereinafter) in data created by an application on one printing paper sheet (to be referred to as a physical page hereinafter), enlargement/reduction printing setting of enlarging/reducing and outputting data, and in a printer having a double-sided printing function of printing on the two sides of a paper sheet, double-sided printing setting.

In addition, stamp setting of adding a stamp such as “for internal use only” in printing a document, and setting such as a special effect in printing a photograph can also be designated.

By performing these printing settings on a user interface (UI) displayed by the printer driver, various data can be printed in an optimal state. The UI of the printer driver can be displayed via an application, or displayed and set via a printer setting function provided by an operating system.

These printing options include a double-sided printing function of printing on the two sides of a paper sheet. Double-sided printing requires a mechanism of reversing a paper sheet. To print on the two sides of a medium by a printer having no such mechanism, only the odd-numbered pages of a document are printed on the front sides of media. The media having only the front sides printed are then reversed and set in the printer again, and only the even-numbered pages of the document are printed.

Printers with an automatic double-sided printing unit serving as a mechanism of performing double-sided printing without cumbersome operation have become popular. The automatic double-sided printing unit is a device which automatically reverses a paper sheet having one side (to be referred to as front side hereinafter) printed and prints on the other side (to be referred to as back side hereinafter) again in order to print on the two sides of the paper sheet. The use of the automatic double-sided printing unit facilitates printing on the two sides of a medium without manually reversing a medium having one side printed, setting the medium again, and printing on the other side. The automatic double-sided printing unit, which has been attached to relatively expensive apparatuses such as a laser beam printer, is recently mounted in even relatively small-size, low-cost apparatuses such as an ink-jet printer.

The printing settings of the printer driver are done for each printing job, and common printing settings are applied to an entire object to be printed in one job. In double-sided printing using the automatic double-sided printing unit, printing is performed on both front and back sides on the basis of common settings.

However, preferable printing settings may be different between front and back sides in double-sided printing using the automatic double-sided printing unit. For example, in double-sided printing on a postcard, an address plane serving as a front side generally has only a black text, and is printed by grayscale printing at a relatively high speed (speed priority). A correspondence plane serving as a back side often contains a photographic image or illustration, and is printed by color printing at a printing quality with image quality priority. In this manner, suitable settings are different between front and back sides.

Only the same printing settings can be adopted even when so-called border-free printing of printing a photographic image or the like in the full size of a paper sheet is done on a back side (correspondence plane). To print a correspondence plane without any frame, both an address plane and correspondence plane must undergo border-free printing. When border-free printing is designated, a text is often printed using a combination of C, M, and Y color inks without using pigment ink owing to fretting or the like even in a printer which realizes clear text printing by using black pigment ink in printing a text. If border-free printing is designated in double-sided printing in such printer, the text of an address plane is printed in color ink without using black pigment ink, failing in clear printing.

In this manner, the same settings are used for front and back sides, and optimal printing settings cannot be adopted for each side.

### SUMMARY OF THE INVENTION

The present invention has been made to overcome the conventional drawbacks, and has as its object to provide a printing control method and apparatus capable of printing by using settings different between the front and back sides of a document to be printed by one job, and thus performing printing with a high degree of freedom by simple operation when executing printing by a printing apparatus having an automatic double-sided printing unit.

To achieve the above object, the present invention has the following arrangement.

A printing control method of converting original data into print data processible by a printing apparatus, comprises

a setting step of setting a basic setting applied to the whole print data in generating the print data, a double-sided printing setting, and a back-side setting applied to a page corresponding to a back side of a sheet serving as a printing. medium in the double-sided printing setting; and

a conversion step of converting the data into the print data in accordance with the basic setting and the back-side setting set in the setting step.

In double-sided printing, printing can be performed in printing settings different between front and back sides, increasing the printing quality, operability, and printing efficiency.

Preferably, in the conversion step, the basic setting is applied for an item other than an item having the back-side setting.

Settings different from those of a front side may be set by the operator or saved, and high operability and saving of the memory resource can be achieved.

Preferably, in the conversion step, the back-side setting is applied to, as a unit, one side of the sheet serving as a printing medium.

Settings for front and back sides can be performed in accordance with a physical printing medium.

Preferably, in the conversion step, metadata generated by an operating system is converted into the print data in accordance with the basic setting and the back-side setting while the back-side setting is preferentially applied.

While the back side inherits the settings of the front side, only different settings can be reflected.

Preferably, in the conversion step, while the basic setting and the back-side setting are referred to, various parameters necessary to convert a page corresponding to a front side of a sheet and various parameters necessary to convert a page corresponding to a back side are loaded in advance, and the parameters are alternately referred to in converting the pages.

Right-side settings and back-side settings suffice to be applied in the page order, and the processing sequence can be simplified and assured.

Preferably, in the conversion step, every time a page of interest is to be converted, various parameters for use are loaded and referred to by referring to the basic setting and the back-side setting.

Settings to be applied to a page of interest can be reliably reflected in a printing result.

Preferably, the setting step comprises a sheet selection step of selecting a type of sheet serving as a printing medium, and types of sheets in the basic setting and the back-side setting are changed in accordance with the type of sheet selected in the sheet selection step.

Preferably, the method further comprises a step of, upon reception of a printing setting value request from an application which generates the original data, sending back a printing setting value for generating original data convertible into print data corresponding to the basic setting and the back-side setting in the conversion step.

Data which can reliably reflect basic settings and back-side settings can be output to an application which outputs data. Consequently, a printing result which faithfully reflects printing settings can be obtained.

Preferably, in the setting step, the type of sheet subjected to printing can be selected, border-free printing setting can be selected for each of the basic setting and the back-side setting in accordance with the selected type of sheet, and when a type of sheet capable of border-free printing is set, a printable region of border-free printing is sent back to the application.

Border-free printing and border printing can be realized without degrading the printing quality.

Preferably, in the setting step, color printing or monochrome printing can be selected for each of the basic setting and the back-side setting, and color printing setting is sent back to the application.

Even if one of the basic setting and back-side setting represents the color mode and the other represents the monochrome mode, images which reflect the respective settings can be printed.

Preferably, in the conversion step, when the double-sided printing setting is done in the setting step, original data of one page received from the application for one plane is converted into print data and output for all sheets subjected to printing, and original data of each page received from the application for the other plane is converted into print data for the received page.

Even when one plane in double-sided printing is commonly used for all sheets subjected to printing, back-side settings can be applied to a page corresponding to a back side.

Preferably, in the setting step, the basic setting and the back-side setting are changed in accordance with a printing setting designated in the application.

Printing settings can be determined by utilizing settings designated in the application.

To achieve the above object, the present invention alternatively has the following arrangement.

A printing control method of converting input drawing data into print data printable by a printing apparatus and transferring the print data to the printing apparatus, comprises

a step of determining a basic setting serving as a printing setting applied to the whole drawing data;

a step of recording in a setting table the basic setting determined in the basic setting determination step;

a step of, when the drawing data is to be printed on two sides of each of sheets for a plurality of pages, determining a back-side setting applied to only pages corresponding to back sides of the sheets;

a step of recording in the setting table the back-side setting determined in the step of determining the back-side setting; and

a generation step of determining a setting used for each page of interest from the setting table and generating print data on the basis of the determined setting.

Printing can be done in printing settings different between front and back sides in double-sided printing.

Preferably, the generation step comprises

a step of loading a first page of the drawing data from metadata generated by an operating system,

a step of converting data of the first page into print data in accordance with the basic setting and the back-side setting while preferentially applying the back-side setting,

a step of storing the print data of the first page,

a step of loading data of each of second and subsequent pages in the drawing data from the metadata,

a step of converting the data of each of the second and subsequent pages into print data in accordance with the back-side setting,

a step of outputting the print data of the second and subsequent pages to a printer, and

a step of outputting the print data of the first page to the printer after outputting the print data of the second and subsequent pages.

Pages loaded one by one and a page stored in advance are alternately output as respective planes in double-sided printing. At this time, printing can be executed by reflecting the settings of front and back sides. This can reduce the output data amount from the application and increase the printing processing speed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the configuration of a printing system according to the first and second embodiments;

FIG. 2 is a flow chart showing a printing setting sequence according to the first and second embodiments;

FIG. 3 is a table showing a setting table according to the first and second embodiments;

FIG. 4 is a view showing a basic setting window according to the first and second embodiments;

FIG. 5 is a view showing a back-side setting window according to the first and second embodiments;

FIG. 6 is a flow chart showing a processing flow up to execution of printing according to the first embodiment;

FIGS. 7A, 7B, and 7C are views showing data processing states in border-free printing and standard printing according to the first embodiment;

FIG. 8 is a flow chart showing a processing flow up to execution of printing according to the second embodiment; and

FIG. 9 is a block diagram showing a state in which settings are reflected between a printer driver and an application according to the second embodiment.

### DETAILED DESCRIPTION OF THE PREFERRED EMBODIMENTS

Preferred embodiments of the present invention will be described in detail below with reference to the accompanying drawings.

[First Embodiment]

A printing system according to the present invention is a printer driver which converts original data generated by an application program into print data processible by a printing apparatus. The operator can set, via a UI or application program, basic settings applied to the whole print data in generating print data, double-sided printing settings, and back-side settings applied to a page corresponding to the back side of a sheet serving as a printing medium in double-sided printing. In converting original data into print data, the data is converted in accordance with basic settings and back-side settings for double-sided printing while back-side settings are preferentially applied. Accordingly, different printing settings can be done on the front and back sides in double-sided printing by one job. Original data has a format determined by an operating system such as Windows®, and print data is described in a page description language or bitmap data processible by a printer. This printing system can be implemented by, e.g., the following embodiment.

<<Description of Overall System>>

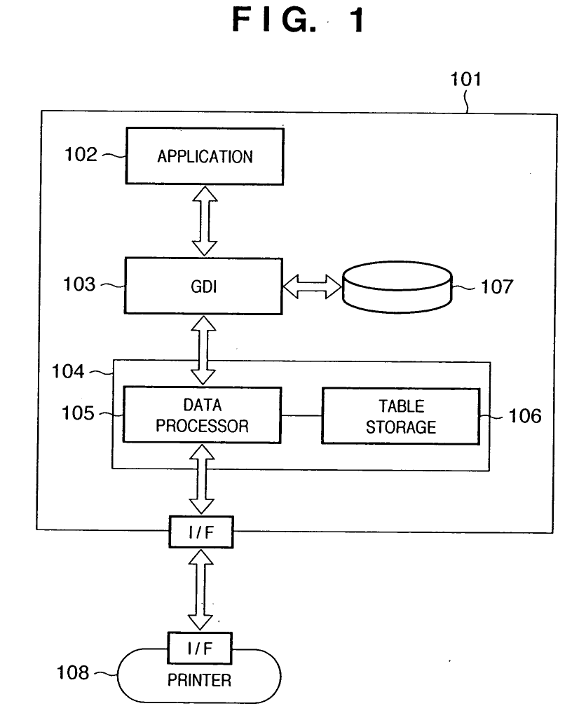

FIG. 1 is a block diagram showing an example of the configuration of a printing system 100 according to the first embodiment of the present invention.

In FIG. 1, application software 102 is software running on an operating system (to be referred to as an OS hereinafter) serving as the basic software of a host computer 101. Examples of the application software 102 are document preparation wordprocessing software, graphic preparation software, and presentation software. The application software 102 has a function of printing created data.

A GDI (Graphic Device Interface) 103 is an output module unique to the Windows® OS, and is an OS subsystem (basic function group) which performs image information processing such as display on a display or printing from a printer. A module corresponding to the GDI 103 is generally called a graphic engine. By using this function, the application can output drawing information in a format independent of a device. The GDI 103 dynamically links and uses the device driver of a designated device such as a display or printer, and thus executes output processing to the device in accordance with a called function. In outputting data to a printer, the GDI 103 outputs data to the printer driver.

In response to a call from the GDI 103, a printer driver 104 converts data into a data format printable by a predetermined printer, and outputs the converted data to the printer. The printer driver 104 has a function of displaying and controlling a printing setting window (UI) for determining settings used to generate print data. The printer driver 104 generates print data on the basis of settings designated on the

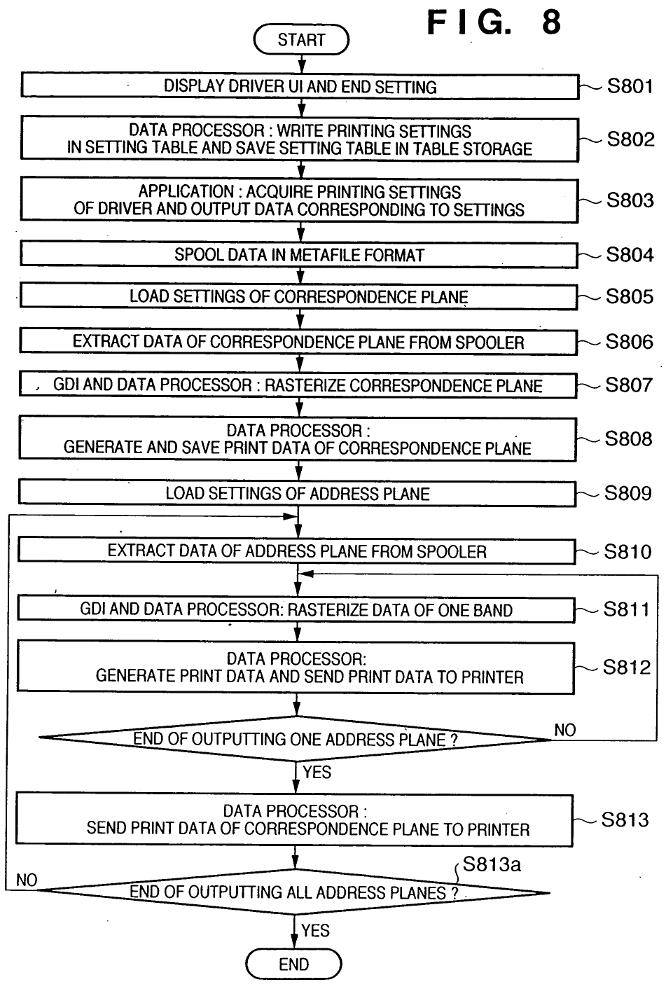

The printer driver 104 according to the first embodiment comprises a data processor 105 and table storage 106. The data processor 105 performs all processes such as the above-described UI control and processing of receiving data from the GDI and generating print data on the basis of UI settings. The table storage 106 is a storage area for storing a setting table for managing printing settings on the UI displayed by the data processor 105. The data processor 105 stores printing setting information as a setting table as shown in FIG. 8 in the table storage 106. In generating print data, the data processor 105 loads necessary page settings from the setting table in the table storage 106, and generates print data corresponding to the settings.

In the first embodiment, the storage area for storing the setting table is ensured as the table storage 106 in the printer driver 104. However, the table need not always be stored in the printer driver 104. For example, the table may be stored in another storage area within the host computer 101, and properly loaded by the printer driver.

Generated print data is transmitted from the host computer 101 to a printer 108 via an interface. The printer 108 forms an image corresponding to the received print data on a paper sheet. In the first embodiment, the printer 108 is an ink-jet printer, and print data is bitmap data (raster data) arranged in the raster scan order. The present invention can be applied to a laser beam printer and the like regardless of the printing method as far as the printer has an automatic double-sided printing function, which will be described later.

<<Description of Application>>

The application 102 comprises a function of separately editing an address plane and correspondence plane. The application 102 further comprises a mode in which only an address plane is printed in executing printing, a mode in which only a correspondence plane is printed, and a mode in which both an address plane and correspondence plane are printed by automatic double-sided printing. In printing only an address or correspondence plane, only corresponding data is output. In the mode in which both an address plane and correspondence plane are printed, an address plane and correspondence plane are alternately output. That is, the application 102 according to the first embodiment may be a generally available document processing application having a function of printing a whole document and a function of printing only odd-or even-numbered pages. If such application creates a document in which an address plane is laid out on an odd-numbered page and a correspondence plane is laid out on an even-numbered page, printing drawing data can be transferred to the OS and printer driver by the above-described method. The application 102 according to the first embodiment may also be a postcard printing program having a function of sequentially loading the records of address planes from a database registered in advance by the user, and alternately outputting the records to address planes (front sides) and characters and images created in advance to correspondence planes (back sides), and a function of printing at once on single planes such as address or correspondence planes.

The first embodiment will exemplify a case wherein automatic double-sided printing of alternately outputting address planes and correspondence planes from an application is performed out of the above-mentioned modes. In this case, the printer driver 104 prints data output from the application 102 on the two sides of a medium (paper sheet) in the output order, and can automatically print a plurality of address planes on front sides and a plurality of correspondence planes on back sides. This processing can be regarded as automatic double-sided printing of a document formed by a plurality of pages by using a document preparation application or the like.

<<Printing Setting Method>>

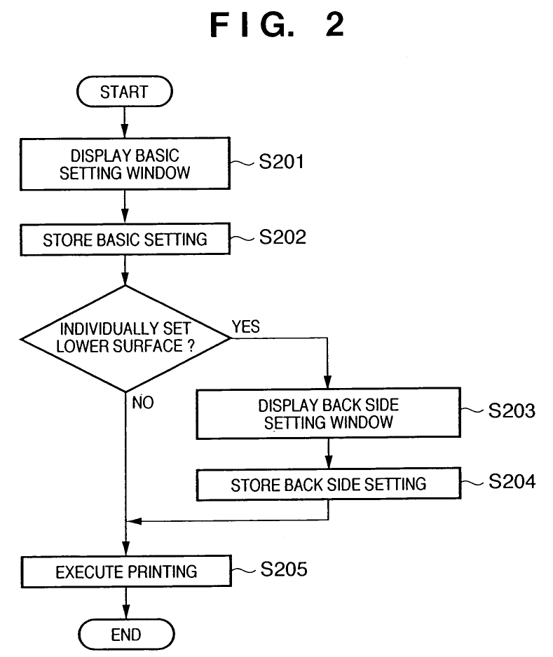

FIG. 2 is a flow chart mainly showing the printing setting step of a processing flow in the printing system 100 according to the first embodiment. This sequence is executed by the data processor 105 of the printer driver 104.

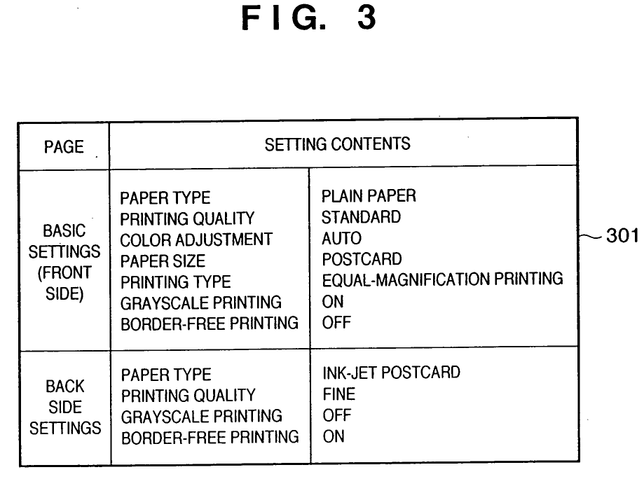

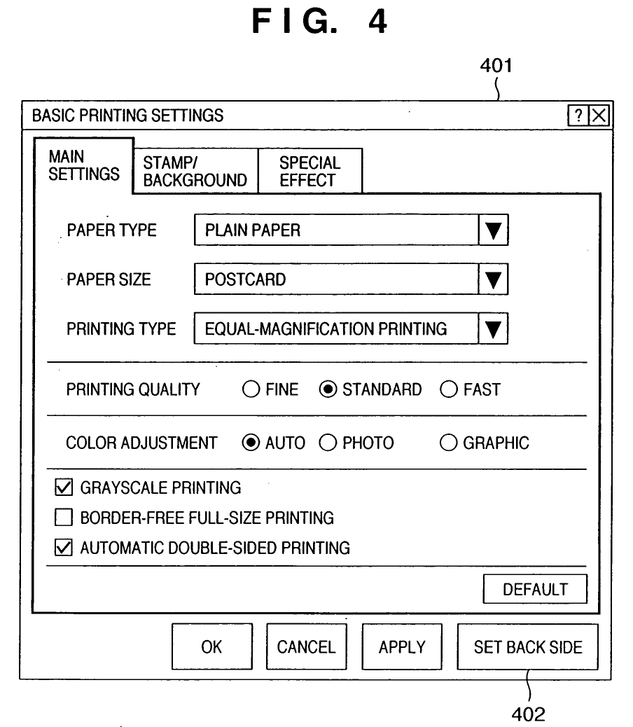

If a printer for use is selected in the printing menu of the application 102 to display the printing setting window of the printer driver, the data processor 105 of the printer driver 104 displays a setting window as shown in FIG. 4 (S201). The displayed setting window is a basic setting window for performing basic settings to be applied to the whole document, and enables various printing settings described above, such as image processing setting and page layout. FIG. 4 is a view showing a basic setting window 401 in the first embodiment. If the “apply” or “OK” button is clicked, set contents are written as basic settings to be applied to the whole document in the “basic setting” column of a setting table 301 as shown in FIG. 3 (S202).

In the example of FIG. 4, the setting items of basic printing settings are eight items “paper type”, “paper size”, “printing type”, “printing quality”, “color adjustment”, “grayscale printing”, “border-free printing”, and “automatic double-sided printing”, in addition to the stamp/background and special effect. Of these items, seven items except “automatic double-sided printing” are registered in the basic setting column of the setting table 301. The items except “automatic double-sided printing” are items for defining how to print each page. To the contrary, “automatic double-sided printing” is an item for designating whether to utilize the automatic double-sided printing function of the printer, and need not be particularly registered in the setting table 301. However, “automatic double-sided printing” may also be registered in the setting table 301.

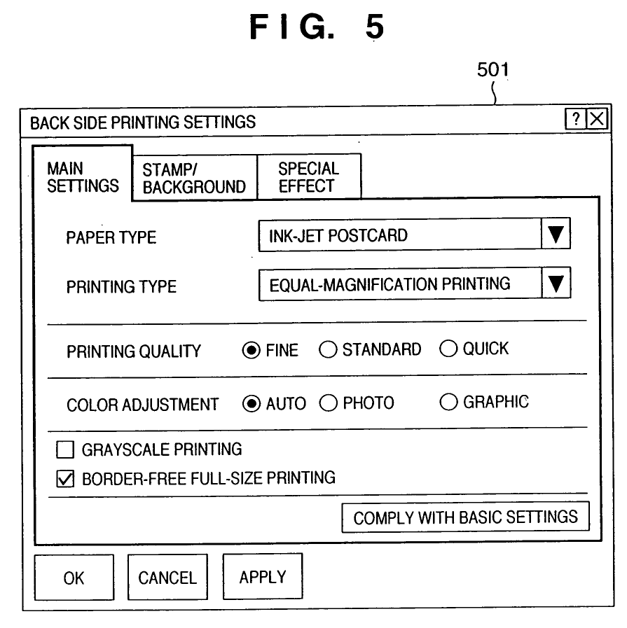

In FIG. 5, the setting items of back-side printing settings are the seven items of basic printing settings, the stamp/background, and the special effect, except “automatic double-sided printing”. All the items of basic printing settings which are registered in the setting table 301 can be set. Reverse-side printing settings need not hold items having values common to those of basic printing settings. In the table shown in FIG. 3, the values of only items that are different from those of basic printing settings are registered as back-side printing settings.

Referring back to FIG. 2, if a whole document is to be printed in the same settings, the operator ends printing settings by only settings in the basic setting window, and clicks the printing execution button to execute printing. The back side is determined not to be individually set, and printing is executed in accordance with designated settings (S205). The printing execution button is provided as, e.g., an item “execute printing” in the printing menu of an application.

If different printing settings are to be applied to the front and back sides of a printing medium, back-side settings are done after basic settings. In this case, basic settings are directly applied to front-side printing. The basic setting window 401 has a back-side setting button 402 serving as an option for printing on a back side in different settings. If the user clicks the back-side setting button 402, a back-side setting window 501 as shown in FIG. 5 is displayed (S203).

The default values of setting items in the back-side setting window are set in the basic setting window in S202, and are the values of basic settings (front-side settings) which are stored in the “basic setting” column of the setting table 301. The user changes only desired items from the setting values of basic settings (front-side settings), and the back side can be printed in settings different from those of the front side. At this time, if the user clicks the “apply” or “OK” button, only items different from basic settings are written as back-side printing settings in the setting table, as shown in FIG. 3 (S204).

After back-side settings end, the user clicks the printing execution button to execute printing. Accordingly, printing is executed at the designated settings (S205).

The setting table in FIG. 3 shows an example in which the paper type is changed from the basic setting “plain paper” to “ink-jet postcard”, the printing quality is changed from the basic setting “standard” to “fine”, the grayscale printing is changed from the basic setting “ON” to “OFF”, and border-free printing is changed from the basic setting “OFF” to “ON”. That is, the front side undergoes border printing on “plain paper” in the “standard” quality, whereas the back side undergoes “border-free” printing on “ink-jet postcard” in the “fine” quality.

These setting differences appear as follows. As for printing quality setting, the printing density in the operation direction of the ink-jet head is changed for each set quality. For example, with “fine” setting, an image is printed at a density two or four times higher than that of “standard” setting. “Border-free” ON and OFF settings appear as the absence and presence of a frame, which will be described later. As described in BACKGROUND OF THE INVENTION, if “border” is set, a black portion is expressed in black ink by even a printer in which black is expressed by so-called process black prepared by synthesizing Y, M, and C inks. These setting differences are reflected in processing as follows.

<<System Processing up to Spool>>

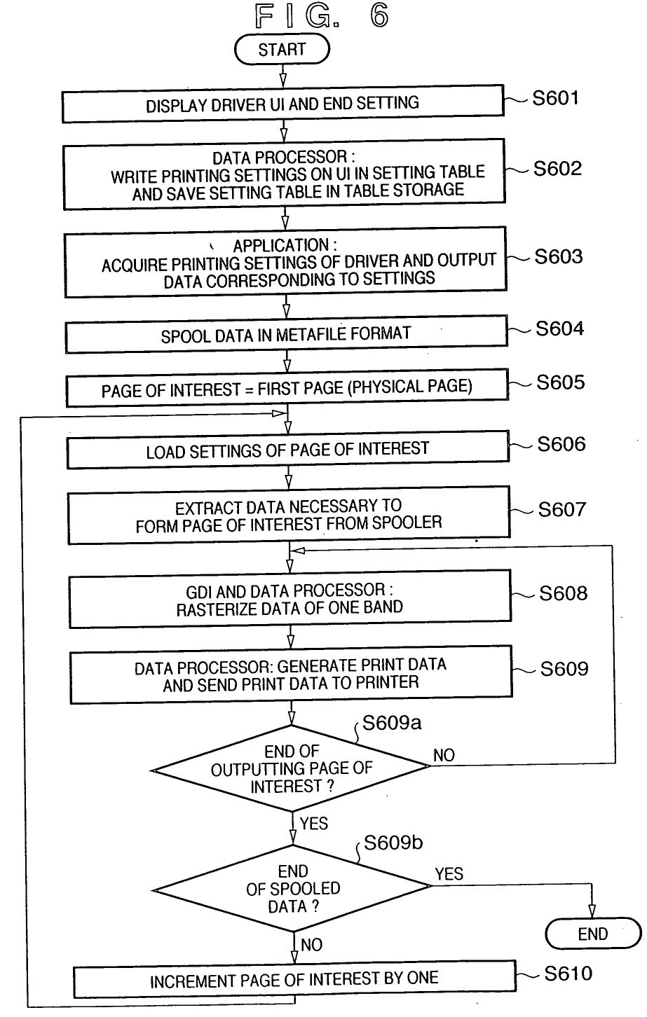

FIG. 6 is a flow chart showing processing from designation of printing by the application 102 up to the end of printing. This flow chart is mainly a process by the printer driver, but partially includes processes by the application and OS in order to explain the operation of the overall printing system.

If the application 102 displays a printing dialog and a printer for use is selected, the data processor 105 of the printer driver 104 displays a printing setting window (S601). Detailed printing settings are performed in the printing setting window by the above-described sequence, and the data processor 105 stores basic settings and back-side settings as a setting table as shown in FIG. 3. If the user clicks the printing button to designate execution of printing, the data processor 105 stores the confirmed setting table in the table storage 106 (S602). The sequence up to this process is the same as that described in steps S201 to S204 of FIG. 2. The setting table may be stored in the table storage 106 by clicking the OK button or confirmation button after setting. If the user clicks the printing button to designate execution of printing, processes in step S603 and subsequent steps are executed.

In step S603, the application 102 requests printing execution settings of the printer driver 104. In response to this request, the data processor 105 sends back to the application some setting values from the setting table stored in the table storage 106. The setting values sent back to the application are as follows.

a: a maximum printable region among the printing settings of front and back sides

b: the default values of the printer driver among items at which different printing settings are possible between front and back sides

c: the setting values of basic settings for the remaining items

As for information on a printable region representing an actual printable region in the paper size, maximum printable region information among paper sizes selected from the printing settings of front and back sides is transferred to the application in order to ensure a margin for data conversion corresponding to settings by the printer driver. More specifically, when a function of changing the printable region is provided, for example, when border-free printing of printing in the full size of a medium without any margin is supported, there are prepared a printing region for performing border-free printing for one paper size and a printing region for performing standard printing free from border-free printing. In general, when border-free printing is selected, the printable region is widened by a frame in border printing, and the output data region from the application can also be widened. To the contrary, when border-free printing is not designated in basic settings but is designated in only back-side settings, and printable region information based on basic settings is transferred to the application, the application outputs data enough to fall within the printable region of standard printing, i.e., the printable region of border printing. To create print data for border-free printing having a larger printable region by the printer driver on the basis of the data, the printer driver must perform processing of simply enlarging data output for standard printing (border-free printing is not performed). This impairs the original effect of border-free printing “data can be printed in a larger region”. To prevent this, it is desirable to send back the printing region of border-free printing to the application when border-free printing is selected for the back side.

In the first embodiment, when border-free printing is selected in basic settings, the printable region used in border-free printing is transferred to the application. As a result, the application outputs border-free printing data, and the printer driver can process data in accordance with settings. Also when a setting item on the printable region exists in addition to border-free printing, “maximum printing region in the current paper size” is sent back.

As for items which can adopt different settings between back and front sides, except the setting item on the printable region, the default setting values of the printer driver are transferred.

This is because settings in output from the application preferably have the default setting values (color) of the printer driver in order to automatically change by the printer driver after the end of output from the application whether to output drawing data in color or monochrome from the application. As for parameters used in color processing, parameters for use are switched by looking up the setting table by the data processor 105 in processing after the end of output from the application 102. Accordingly, printing in different settings can be realized. For this purpose, printing settings transferred to the application 102 are the default setting values of the printer driver. In subsequent steps, the printer driver performs processing corresponding to the setting table for data output from the application with the default settings. As for the setting values of the resolution and page layout, the default values of the printer driver are transferred because an output from the application 102 is data based on the default settings of the printer driver in consideration of the possibility that enlargement/reduction processing may be done by the printer driver for N-up printing or the like. This assumes that the default values of the printer driver are a high resolution value, color designation in color/monochrome designation, and a 1-up page layout.

In this manner, setting values transferred from the printer driver to the application are values which do not impair the purpose of setting even if the printer driver processes data in accordance with different setting values. For example, as for the printable region, if the printer driver receives data of a narrow range from the application, the printer driver cannot convert the data into print data of a wide range unless it performs processing not complying with the original purpose of enlargement processing. If, however, the printer driver receives data of a wide range, it can easily convert the data into print data of a narrow range by masking. Conversion from color image data to monochrome image data can be achieved by multiplying color components by a predetermined coefficient and adding the resultant components, but back conversion is difficult. When image data corresponding to a low printing density is received from the application in order to, for example, receive bitmap data from the application and convert it into print data, no high-quality image can be obtained even by image data conversion corresponding to a high density by interpolation processing or the like.

For example, among the items of FIG. 3, a resolution for “printing quality” =“fine”, color/monochrome information for “grayscale printing” =OFF, and a printable region (when border-free printing is possible) for “border-free printing” =ON are transferred to the application.

As for items such as the paper size which cannot be changed between front and back sides, the setting values of basic settings are transferred, as described above.

The application 102 calls a GDI function on the basis of settings acquired from the printer driver 104 and outputs data, and the printer driver 104 receives the drawing function (S603). At this time, the application alternately outputs data for sets of an address plane and correspondence plane, as described above. More specifically, the first data is read out from an address book subjected to printing, and data laid out in accordance with the address plane layout is output as the first page. Subsequently, correspondence plane data edited in the correspondence plane editing window is output as the second page. Processing “address plane data output→ correspondence plane data output” is repeated until all address data to be printed are output, thereby alternately outputting address planes and correspondence planes.

After the application ends output, the data processor 105 of the printer driver spools, in a spooler, data of all pages in a metafile format having no setting information while checking various settings upon output from the application (S604). At this time, the application is freed. Since the application repeats output of an address plane → correspondence plane, the same processing as that in printing a normal document of pages is performed without considering the data order in spooling a metafile.

The metafile is so-called intermediate data which does not depend on the device and can be interpreted by any printer and any other output device. The metafile is converted into a format processible by the printer driver 104 and printer 108.

Processing of spooling an output from the application as a metafile may be executed within the printer driver or realized by the subsystem of the OS.

The following print data generation/output processing by the printer driver can start before the end of output from the application. That is, when the application 102 outputs one page, the printer driver 104 acquires the data as a metafile, generates print data of one page, and outputs it to the printer. After that, immediately when the application outputs data of one page, the printer driver generates print data of the page and outputs it. By repeating this processing, printing can start before the end of output from the application.

Processing of generating print data by the printer driver from an output from the application will be described in detail. The following processing assumes that after the application outputs all pages, the printer driver generates a print file for each page from the spooled metafile, and outputs the print file to the printer.

<<Processing After Spool>>

After spool, the data processor 105 looks up the setting table stored in the table storage 106, defines the first page of each physical page to be actually printed as the first page of interest (S605), and loads settings used for printing (S606). If the page of interest is an odd-numbered page, this page corresponds to a front side, and thus the data processor 105 loads only basic settings from the setting table. If the page of interest is an even-numbered page, this page corresponds to a back side. If the setting table does not hold any back-side setting, the data processor 105 loads and uses only basic settings. If the table holds back-side settings, the data processor 105 loads both basic settings and back-side settings to the memory looked up by the printer driver. The setting values of back-side settings are used for items described in back-side settings, and the setting values of basic settings are used for the remaining items. In other words, back-side settings are applied when automatic double-sided printing setting is done and the page of interest is an even-numbered physical page.

Generation of print data is repeated for each physical page. In N-up printing of laying out a. plurality of logical pages on one physical page, logical pages which form one physical page must be processed at once. Of settings for the current page of interest, the setting value of the page layout is checked, and the metafile of logical pages necessary to form a page is loaded from the spooler. For example, when 2-up printing has been set, two logical pages are loaded, and the loaded metafile is rasterized in a layout corresponding to the current settings.

In the first embodiment, the application 102 alternately outputs an address plane and correspondence plane for each page, and a physical page to be actually printed coincides with the number of spooled logical pages. To form the current page of interest, the metafile of logical pages of one page is loaded from the spooler (S607). The data processor 105 rasterizes the loaded metafile in accordance with the current settings. The data processor 105 then performs image processing and the like, generates print data, and outputs it to the printer.

In the first embodiment, a page is divided by a predetermined band width, and processing of one page is executed for each band. In step S608, the data processor 105 rasterizes data for each band to generate band data. In step S609, the printer driver 104 executes processing of, e.g., converting the raster data from RGB to CMYK, generates print data, and sends it to the printer 108. At this time, print data is generated by adding currently necessary commands such as a command representing double-sided printing and a command representing a front or back side in double-sided printing. This processing is repeated till the end of one page, ending output of one page. Steps S608 and S609 are repeated until processing ends for one page of bands (S609a).

After the page of interest is output, the spooler is checked (S609b). If spooled data exists, the page of interest is incremented by one (S610), and the same processing is performed. This processing is repeated until all spooled data are processed, ending printing of all pages.

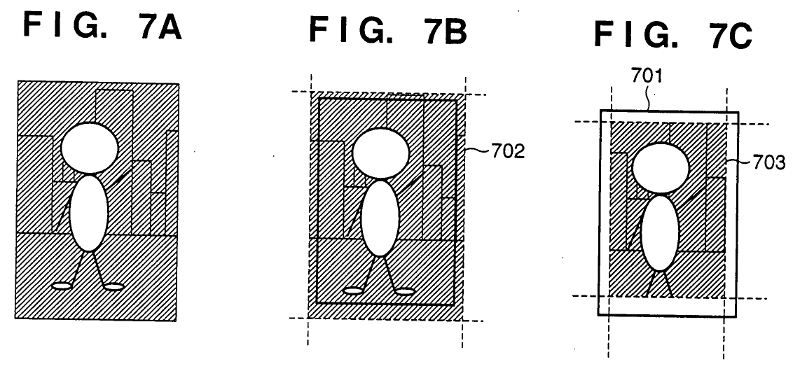

To generate print data by conversion of rasterized data from RGB to CMYK, quantization, and the like, data must be processed in accordance with the printing region settings of front and back sides. As described above, all data output from the application have a size based on the printable region of border-free printing as shown in FIG. 7A. When border-free printing is designated in settings applied to the page of interest, print data is generated using all data prepared by rasterizing outputs from the application, thereby generating data (border-free printing data) to be output to the printer, as shown in FIG. 7C. To the contrary, when no border-free printing is set in settings applied to the page of interest, a printable region 703 of standard printing (no border printing is done) is masked for rasterized data, and only a data region to be generated in standard printing is extracted to generate print data. Data generated by this processing is identical to print data generated using all data output from the application when the printable region 703 of standard printing is transferred to the application in advance. This processing eliminates the need for switching settings by the application. The printer driver can properly switch various settings including ON/OFF of border-free printing between front and back sides in the setting table on the basis of data output from the application in accordance with the same printable region information.

Even a printer which prints a text by using black pigment ink only in standard printing can realize clear text printing using black pigment ink by setting border-free full-size printing for a correspondence plane and standard printing free from border-free printing for an address plane.

By the above processing, printing settings can be done for each of front and back sides, and the set printing settings can be automatically switched during one job and used to perform printing.

In the first embodiment, settings to be applied to a page of interest are loaded every time the page of interest is incremented. Alternatively, the printer driver 104 may directly access the table storage 106 to look up the setting values of the page of interest. Also, basic settings and back-side settings may be loaded to the memory of the printer driver in advance. At this time, the basic settings and back-side settings are combined to determine settings used in back-side printing. In printing each page, the settings loaded in advance are properly used in accordance with whether the page of interest is a front or back side.

The application 102 has been described as a postcard editing application, but the same effects can also be obtained using a general document editing application or the like. In this case, generation of print data is repeated for each physical page, as described above. In N-up printing of laying out a plurality of logical pages on one physical page, logical pages which form one physical page are processed at once. In S607, the metafile of logical pages necessary to form the current page of interest must be loaded from the spooler and processed.

The processing flow is illustrated in FIG. 6 as a series of procedures for descriptive convenience, and includes steps executable as independent processes depending on the processing entity. For example, steps S601 and S602 need not always be done immediately before printing processing, but may be appropriately executed.

[Second Embodiment]<<Description of Overall System>>

The second embodiment adopts the same arrangement as that of the printing system 100 in the first embodiment. As will be described below, the function of an application 102 is different from that of the first embodiment, and the processing sequence of a printer driver 104 is also different from the first embodiment in accordance with the application.

<<Description of Application>>

The application 102 has a printing setting function of, e.g., designating a printer used for printing. The application 102 further includes a means for changing the editable region of an editing window in accordance with the setting contents of printing settings. The application 102 generates data enough to fall within a region displayed in the editing window. Since the printable region of each medium size changes depending on the printer model, the printable region of a currently selected printer is reflected in the editing window of the application 102. The user can grasp in advance a region within which data can be actually printed without any omission, preventing a printing failure.

The application 102 also includes a page setting function of changing the printable region on the basis of whether to perform border-free printing (whether to edit border-free printing data) when a function of changing the printable region is provided, for example, when a selected printer supports border-free printing. Page settings can be individually done for a correspondence plane and address plane, and reflected in the editing window of the application. For example, when “border-free printing” is designated in the page settings of the correspondence plane, the application inquires, of the printer driver, the printable region of border-free printing in a currently selected paper size, and reflects the acquired size in the correspondence plane editing window. Data is created in this state, and data output from the application also becomes data of a region usable in border-free printing. No border-free printing is designated for the address plane, and the editable region is kept slightly narrower than the paper sheet.

Settings in page settings are also reflected in printer driver settings. Of page settings set by the application 102, items included in the setting table are transferred from the application 102 to the OS or to the printer driver 104 via the OS, and reflected in a setting table stored in a table storage 106. When page settings are individually performed for an address plane and correspondence plane, an option “individually set back side” is assumed to be selected in the printing settings of the printer driver. Of the page settings of the correspondence plane in the application, settings different from the page settings of the address plane are reflected in the back-side settings of the printer driver, and recorded in a setting table 301 identical to that in the first embodiment. This state is reflected in displaying a driver UI. The application 102 determines whether settings included in page settings are to be reflected in the setting table, on the basis of data of settable items corresponding to the printer type provided by, e.g., the OS. The application 102 can transfer setting values to the OS or printer driver.

When a printer capable of automatic double-sided printing is selected in the printing settings of the application, an option for performing automatic double-sided printing can be selected. If automatic double-sided printing is selected, correspondence plane data and address information registered in the address book of the application are sequentially output in accordance with a layout edited in the address plane editing window in executing printing. As the data output method, correspondence plane data may be output once, and then address plane data may be output by the number of addresses. Similar to the first embodiment, output in the order “address plane data→correspondence plane data” may be repeated by the number of addresses. A means for defining the data output method between the printer driver and the application is provided, and the method complies with the definition. If automatic double-sided printing is selected, this setting is also reflected in printer driver settings.

In the second embodiment, the following processing assumes that automatic double-sided printing is selected in the above-mentioned printing settings, and the application first outputs a correspondence plane once and then sequentially outputs all address planes in the address book order.

<<Printing Setting Method>>

The printing setting sequence is the same as that shown in FIG. 2. If a printer for use is selected in the printing menu of the application 102 to display the printing setting window of the printer driver, a basic setting window 401 as shown in FIG. 4 is displayed (S201), and setting contents are written as basic settings in the setting table 301 (S202), similar to the first embodiment.

Since automatic double-sided printing is set in the printing settings of the application 102, an option “automatic double-sided printing” has already been selected in the basic setting window of the printer driver, allowing selection of a button “perform back-side setting”. If a setting of changing the printable region, e.g., border-free printing is done in the page settings of an address plane in the application 102, this setting value is also reflected in the basic settings of the printer driver.

To print in the same settings for front and back sides, printing settings end by only settings in the basic setting window 401. The printing execution button is clicked to execute printing, and printing is then executed at the designated settings (S205). To print in settings different between front and back sides, settings used to print on a back side are done by the same method as that in the first embodiment after basic settings. As a result, only items different from basic settings are written as back-side settings in the setting table 301 (S204).

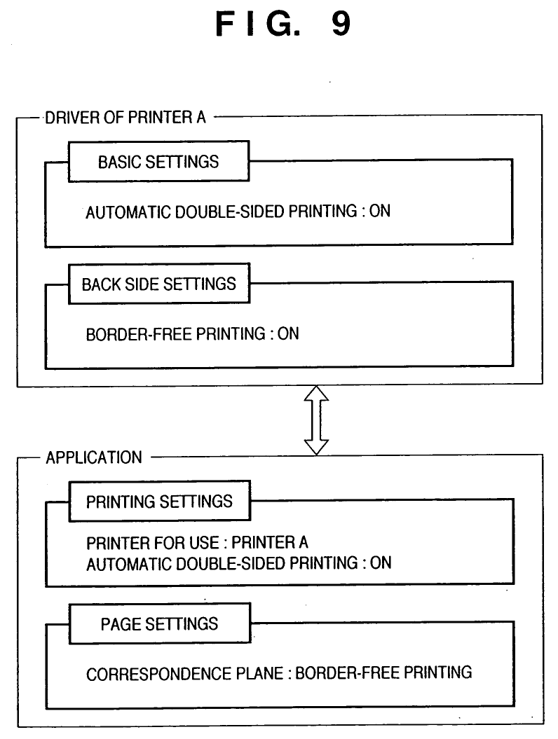

Setting contents in the page settings of the correspondence plane are reflected in the back-side settings of the printer driver, similar to setting contents in the page settings of the address plane in the application that are reflected in the basic settings of the printer driver. Even if back-side settings are not individually performed in the basic setting window of the printer driver, items for which settings different from those of the address plane have been done in the page settings of the correspondence plane in the application have already been set individually in back-side settings. For example, when border-free printing is selected in the page settings of the correspondence plane, the editing window of the application reflects the printable region of border-free printing, and at the same time, this information is transferred to the printer driver. When the printer driver UI is opened, back-side settings have already been done individually, and border-free printing has been selected in back-side settings. To the contrary, when no border-free printing is selected in the page settings of the application, the back-side setting window of the printer driver UI is opened to select border-free printing, and this information is transferred to the application. Upon reception of the information that border-free printing has been selected, the application sets border-free printing in the page settings of the correspondence plane, and this setting is also reflected in the printing region of the editing window. FIG. 9 is a view showing a state in which the settings of the application and printer driver are reflected. In FIG. 9, if automatic double-sided printing and border-free printing for the correspondence plane are set in the page settings of the application, these settings are reflected as automatic double-sided printing in the basic settings of the setting table and border-free printings in back-side settings.

After back-side settings end, the printing execution button is clicked to execute printing. Printing is therefore executed in the designated settings (S205).

Also in the second embodiment, a setting table upon a change similarly to the first embodiment is held in the format as shown in FIG. 3.

<<System Processing up to Spool>>

FIG. 8 is a flow chart showing processing from designation of printing by the application up to the end of printing.

If the application 102 displays a printing dialog, a data processor 105 of a printer driver corresponding to a printer selected as a printer for use displays a printing setting window (S801). Detailed printing settings are performed in the printing setting window by the above-described sequence, and basic settings and back-side settings are stored as a setting table as shown in FIG. 3. If the printing button is clicked to designate execution of printing, the confirmed setting table is stored in the table storage 106 (S802).

The application 102 requests printing execution settings of the printer driver 104. In response to this request, the data processor 105 sends back to the application the setting values of basic settings from the setting table stored in the table storage 106. Since automatic double-sided printing has been selected in the application and is also reflected in the printer driver, information “automatic double-sided printing= ON” is also set in settings transferred from the printer driver to the application.

As for items whose settings can be changed between front and back sides, except an item on the printing region, the default setting values of the printer driver are transferred, similar to the first embodiment.

Data is output by calling a GDI function on the basis of updated settings and a data output method transferred from the printer driver (S803). At this time, a correspondence plane is output once, and then a plurality of address planes are output, as described above. For this purpose, the correspondence plane is output by calling a GDI function on the basis of the page settings of the correspondence plane. For example, if the correspondence plane has border-free printing setting, data corresponding to the printing region of border-free printing is output.

A plurality of address plane data to be printed are output one by one. One address data to be printed is read out from address book data accessory to the application, laid out in accordance with the address plane layout, and output by a GDI call on the basis of printable region information in the page settings of the address plane. Output of an address plane is repeated by a necessary number of times, ending output of address planes.

Similar to the first embodiment, the data processor 105 of the printer driver 104 spools, in a spooler, data of all pages in a metafile format having no setting information while checking various settings upon output from the application (S804). At this time, the application is freed.

Processing of spooling an output from the application as a metafile may be executed within the printer driver or realized by the subsystem of the OS.

<<Processing After Spool>>

After spool, the data processor 105 looks up the setting table stored in the table storage 106, and loads settings used for printing a correspondence plane (S805). The correspondence plane corresponds to a back side, and if no back-side setting individually exists in the setting table, only basic settings are loaded and used. If back-side settings individually exist, both basic settings and back-side settings are loaded to the memory looked up by the printer driver. The setting values of back-side settings are used for items described in back-side settings, and the setting values of basic settings are used for the remaining items.

The metafile of the correspondence plane is loaded from the spooler (S806), and rasterized on the basis of settings to be applied (S807). Image processing and the like are performed to generate print data of the correspondence plane (S808). The generated print data of the correspondence plane is saved for a subsequent print output.

After the print data of the correspondence plane is generated, printer driver of address planes are generated. Since a plurality of data of address planes have been spooled, processing of generating one address plane print data, transmitting it to a printer 108, and transmitting the generated correspondence plane print data to the printer 108 is repeated by the following sequence.

Basic settings serving as front-side settings are loaded (S809). One of address plane data is extracted in the spool order (S810), and rasterized on the basis of the basic settings (S811). Image processing and the like are performed to generate print data, and the generated print data of one address plane is output to the printer (S812). Thereafter, the print data of the correspondence plane that has already been generated is output to the printer (S813).

Similarly, processing of loading metadata of one address plane, generating print data on the basis of settings applied to the address plane, outputting the print data to the printer, and subsequently outputting the print data of the correspondence plane which has already been generated is repeated until all address plane data are processed (S813a).

In the second embodiment, a page is divided by a predetermined band width, and processing of one page is executed for each band. In step S811, the printer driver 104 rasterizes data for each band to generate band data. In step S812, the printer driver 104 executes processing of, e.g., converting the raster data from RGB to CMYK, generates print data, and sends it to the printer 108 (S812). This processing is repeated till the end of one page, ending output of one address plane. This also applies to step S813, and print data of one page is output for each band.

By the above processing, a plurality of printing settings can be done for each page, and the set printing settings can be automatically switched during one job and used to perform printing.

In the second embodiment, printing settings in the application are also reflected in the setting table looked up by the printer driver.

When basic settings have already been loaded in loading settings used for a correspondence plane and are not canceled yet, the basic settings need not be loaded again in printing an address plane and can be directly adopted.

Printing setting data held in the setting table is loaded by loading the settings of an address plane in generating print data of the address plane and loading the settings of a correspondence plane in generating print data of the correspondence plane. However, the loading method is not limited to this.

For example, at the end of spooling an output from the application, both the settings of an address plane and those of a correspondence plane may be loaded and held in the memory looked up by the printer driver.

In the second embodiment, data of a page corresponding to a back side is held in advance by the printer driver, and inserted after a page corresponding to a front side. However, the data order may be reversed. More specifically, data of a page corresponding to a front side is held in advance by the printer driver, and inserted before a page corresponding to a back side. Also in this case, back-side printing settings are applied to back-side data received one by one from the application. For example, in receiving drawing data of a correspondence plane from the application in advance, whether to insert the data as an even-or odd-numbered page is designated. If the data is designated as an odd-numbered page, pages received one by one are defined as back sides, and back-side settings are applied. If the data is designated as an even-numbered page, a page received in advance is defined as a back side, and back-side settings are applied.

Printing is executed by different applications in the first and second embodiments, but the printer driver 104 can be the same. In this case, the printer driver 104 causes the application whether to alternately receive drawing data of an address plane and correspondence plane from the application and output the data in the reception order, like the first embodiment, or to insert and output the page of a correspondence plane received in advance between address planes, like the second embodiment. In accordance with the designation, the printer driver can execute an operation suited to an application of any form.

The present invention may be applied to a system including a plurality of devices (e.g., a host computer, interface device, reader, and printer) or an apparatus (e.g., a copying machine, printer, or facsimile apparatus) formed from a single device.

The object of the present invention is also achieved when the computer (or the CPU or MPU) of a system or apparatus reads out and executes program codes stored in a storage medium which stores software program codes for realizing the functions of the above-described embodiments.

In this case, the program codes read out from the storage medium realize the functions of the above-described embodiments, and the storage medium which stores the program codes constitutes the present invention.

The storage medium for supplying the program codes includes a floppy® disk, hard disk, optical disk, magnetooptical disk, CD-ROM, CD-R, magnetic tape, nonvolatile memory card, and ROM.

The functions of the above-described embodiments are realized when the computer executes the readout program codes. Also, the functions of the above-described embodiments are realized when an OS (Operating System) or the like running on the computer performs part or all of actual processing on the basis of the instructions of the program codes.

Furthermore, the functions of the above-described embodiments are also realized when the program codes read out from the storage medium are written in the memory of a function expansion board inserted into the computer or the memory of a function expansion unit connected to the computer, and then the CPU of the function expansion board or function expansion unit performs part or all of actual processing on the basis of the instructions of the program codes.

[Effects of the Invention]

As has been described above, the image processing apparatus according to the present invention can perform individual settings for the front and back sides of a printing medium in one printing job, instead of applying the same printing settings for entire data to be printed.

Since printing settings given on the UI are managed as a table, printing can be performed while two settings are switched during one printing job.

In printing settings, setting values in a standard basic setting window are used as the default setting values of individual back-side settings. This realizes printing at a high degree of freedom by simple operation.

As many apparently widely different embodiments of the present invention can be made without departing from the spirit and scope thereof, it is to be understood that the invention is not limited to the specific embodiments thereof except as defined in the appended claims.

What is claimed is:

1. A printing control method of converting original data into print data processible by a printing apparatus, comprising:
a setting step of setting a basic setting applied to the whole print data in generating the print data, a double-sided printing setting, and a back-side setting applied to a page corresponding to a back side of a sheet serving as a printing medium in the double-sided printing setting; and
a conversion step of converting the data into the print data in accordance with the basic setting and the back-side setting set in the setting step.

2. The method according to claim 1, wherein in the conversion step, the basic setting is applied for an item other than an item having the back-side setting.

3. The method according to claim 1, wherein in the conversion step, the back-side setting is applied to, as a unit, one side of the sheet serving as a printing medium.

4. The method according to claim 1, wherein in the conversion step, metadata generated by an operating system is converted into the print data in accordance with the basic setting and the back-side setting while the back-side setting is preferentially applied.

5. The method according to claim 1, wherein in the conversion step, while the basic setting and the back-side setting are referred to, various parameters necessary to convert a page corresponding to a front side of a sheet and various parameters necessary to convert a page corresponding to a back side are loaded in advance, and the parameters are alternately referred to in converting the pages.

6. The method according to claim 1, wherein in the conversion step, every time a page of interest is to be converted, various parameters for use are loaded and referred to by referring to the basic setting and the back-side setting.

7. The method according to claim 1, wherein the setting step comprises a sheet selection step of selecting a type of sheet serving as a printing medium, and types of sheets in the basic setting and the back-side setting are changed in accordance with the type of sheet selected in the sheet selection step.

8. The method according to claim 1, further comprising a step of, upon reception of a printing setting value request from an application which generates the original data, sending back a printing setting value for generating original data convertible into print data corresponding to the basic setting and the back-side setting in the conversion step.

9. The method according to claim 8, wherein in the setting step, the type of sheet subjected to printing can be selected, border-free printing setting can be selected for each of the basic setting and the back-side setting in accordance with the selected type of sheet, and when a type of sheet capable of border-free printing is set, a printable region of border-free printing is sent back to the application.

10. The method according to claim 8, wherein in the setting step, color printing or monochrome printing can be selected for each of the basic setting and the back-side setting, and color printing setting is sent back to the application.

11. The method according to claim 8, wherein in the conversion step, when the double-sided printing setting is done in the setting step, original data of one page received from the application for one plane is converted into print data and output for all sheets subjected to printing, and original data of each page received from the application for the other plane is converted into print data for the received page.

12. The method according to claim 8, wherein in the setting step, the basic setting and the back-side setting are changed in accordance with a printing setting designated in the application.

13. A printing control method of converting input drawing data into print data printable by a printing apparatus and transferring the print data to the printing apparatus, comprising:
a step of determining a basic setting serving as a printing setting applied to the whole drawing data;
a step of recording in a setting table the basic setting determined in the basic setting determination step;
a step of, when the drawing data is to be printed on two sides of each of sheets for a plurality of pages, determining a back-side setting applied to only pages corresponding to back sides of the sheets;
a step of recording in the setting table the back-side setting determined in the step of determining the back-side setting; and
a generation step of determining a setting used for each page of interest from the setting table and generating print data on the basis of the determined setting.

14. The method according to claim 13, wherein the generation step comprises
a step of loading a first page of the drawing data from metadata generated by an operating system,
a step of converting data of the first page into print data in accordance with the basic setting and the back-side setting while preferentially applying the back-side setting,
a step of storing the print data of the first page,
a step of loading data of each of second and subsequent pages in the drawing data from the metadata,
a step of converting the data of each of the second and subsequent pages into print data in accordance with the back-side setting,
a step of outputting the print data of the second and subsequent pages to a printer, and
a step of outputting the print data of the first page to the printer after outputting the print data of the second and subsequent pages.

15. A printing control apparatus which converts original data into print data processible by a printing apparatus, comprising:
setting means for setting a basic setting applied to the whole print data in generating the print data, a double-sided printing setting, and a back-side setting applied to a page corresponding to a back side of a sheet serving as a printing medium in the double-sided printing setting; and
conversion means for converting the data into the print data in accordance with the basic setting and the back-side setting set by said setting means.

16. A printing control apparatus which converts input drawing data into print data printable by a printing apparatus and transferring the print data to the printing apparatus, comprising:
means for determining a basic setting serving as a printing setting applied to the whole drawing data;
means for recording in a setting table the basic setting determined by said basic setting determination means;
means for, when the drawing data is to be printed on two sides of each of sheets for a plurality of pages, determining a back-side setting applied to only pages corresponding to back sides of the sheets;
means for recording in the setting table the back-side setting determined by said means for determining the back-side setting; and
generation means for determining a setting used for each page of interest from the setting table and generating print data on the basis of the determined setting.

17. A computer program product which records a program for converting original data into print data processible by a printing apparatus, wherein the program includes
a code for a setting step of setting a basic setting applied to the whole print data in generating the print data, a double-sided printing setting, and a back-side setting applied to a page corresponding to a back side of a sheet serving as a printing medium in the double-sided printing setting; and
a code for a conversion step of converting the data into the print data in accordance with the basic setting and the back-side setting set in the setting step.

18. A computer program product which records a program for converting input drawing data into print data printable by a printing apparatus and transferring the print data to the printing apparatus, wherein the program includes
a code for a step of determining a basic setting serving as a printing setting applied to the whole drawing data;
a code for a step of recording in a setting table the basic setting determined in the basic setting determination step;
a code for a step of, when the drawing data is to be printed on two sides of each of sheets for a plurality of pages, determining a back-side setting applied to only pages corresponding to back sides of the sheets;
a code for a step of recording in the setting table the back-side setting determined in the step of determining the back-side setting; and
a code for a generation step of determining a setting used for each page of interest from the setting table and generating print data on the basis of the determined setting.
